(19) United States
(12) Patent Application Publication
(10) Pub. No.: US 2004/0263398 A1
(43) Pub. Date: Dec. 30, 2004

(54) Electronic device with a retractable antenna assembly

(75) Inventor: Roman Cheng, Junghe City (TW)

Correspondence Address: LINIAK, BERENATO & WHITE, SUITE 240, 6550 ROCK SPRING DRIVE, BETHESDA, MD, 20817-1132, US

(73) Assignee: SANDFAR TECHNOLOGY CO., LTD.

(21) Appl. No.: 10/857,507

(22) Filed: Jun. 1, 2004

(30) Foreign Application Priority Data
Jun. 30, 2003 (TW) 092212000

(51) Int. Cl. H01Q 1/24

(52) U.S. Cl. 343/702

(57) ABSTRACT

In an electronic device, a pivot member of a cam follower unit is coupled pivotally to a retractable antenna assembly that is operable so as to move relative to a casing from a retracted position, where the antenna assembly is retracted into the casing, to an extended position, where the antenna assembly extends outwardly of the casing in a first direction. A cam groove unit is formed in the casing, and permits movement of the pivot member therealong such that the antenna assembly is able to move in the first direction from the retracted position to the extended position or in a second direction opposite to the first direction from the extended position to the retracted position. A biasing member is connected to the casing and the antenna assembly for biasing the antenna assembly in the first direction.

### CROSS-REFERENCE TO RELATED APPLICATION

This application claims priority of Taiwanese Application No. 092212000, filed on Jun. 30, 2003.

### BACKGROUND OF THE INVENTION

1. Field of the Invention

The invention relates to an electronic device, more particularly to an electronic device with a retractable antenna assembly.

2. Description of the Related Art

FIG. 1 illustrates a conventional wireless network card 1 that includes a casing, a retractable antenna assembly 15, a guiding seat 14 and a coiled spring 16. The casing includes complementary casing parts 10, one of which is formed with a set of positioning posts 12, 13. The guiding seat 14 is disposed in the casing, and is mounted detachably therein by engagement with the positioning posts 12, 13 on said one of the casing parts 10. The guiding seat 14 is formed with a spring-mounting rod 141, and an engaging protrusion 142. The antenna assembly 15 is operable so as to move relative to the casing from a retracted position, where the antenna assembly 15 is retracted into the casing, to an extended position, where the antenna assembly 15 extends outwardly of the casing. The antenna assembly 15 includes an antenna-mounting seat 150 mounted pivotally with an antenna. The antenna-mounting seat 150 is formed with a pair of parallel engaging rails 151 that confine an engaging groove 152 for engaging slidably the engaging protrusion 142 on the guiding seat 14 such that the antenna-mounting seat 150 is movable relative to the guiding seat 14. A pivot piece 17 is mounted pivotally on the antenna-mounting seat 150. The pivot piece 17 engages a retaining groove (not shown) formed in the engaging protrusion 142 when the antenna assembly 15 is in the retracted position. When the pivot piece 17 is disengaged from the retaining groove in the engaging protrusion 142, the pivot piece 17 is movable along a positioning groove (not shown) formed in the engaging protrusion 142 such that the antenna assembly 15 is able to move from the retracted position to the extended position. The coiled spring 16 is sleeved on the spring-mounting rod 141 and is retained between the antenna-mounting seat 150 and the guiding seat 14 for biasing the antenna assembly 15 to the extended position.

Since the guiding seat 14 and the positioning posts 12, 13 are made of plastic material having relatively poor rigidity, and since the guiding seat 14 detachably engages the positioning posts 12, 13, reliable retention of the guiding seat 14 in the casing cannot be ensured.

### SUMMARY OF THE INVENTION

Therefore, the object of the present invention is to provide an electronic device with a retractable antenna assembly, which can be securely and accurately positioned in one of retracted and extended positions.

According to the present invention, an electronic device comprises:

a casing;

a retractable antenna assembly disposed in the casing and operable so as to move relative to the casing from a retracted position, where the antenna assembly is retracted into the casing, to an extended position, where the antenna assembly extends outwardly of the casing in a first direction;

a cam follower unit including a pivot member coupled pivotally to the antenna assembly;

a cam groove unit formed in the casing, and including

a first cam groove that corresponds to the extended position of the antenna assembly,

a second cam groove that permits sliding movement of the pivot member of the cam follower unit therealong when the antenna assembly is moved in a second direction opposite to the first direction from the extended position to a first limit position,

a third cam groove that permits sliding movement of the pivot member of the cam follower unit therealong when the antenna assembly is moved in the first direction from the first limit position to the retracted position,

a fourth cam groove that corresponds to the retracted position of the antenna assembly, and that receives the pivot member of the cam follower unit to arrest further movement of the antenna assembly in the first direction,

a fifth cam groove that permits sliding movement of the pivot member of the cam follower unit therealong when the antenna assembly is moved in the second direction from the retracted position to a second limit position, and

a sixth cam groove that permits sliding movement of the pivot member of the cam follower unit therealong when the antenna assembly is moved in the first direction from the second limit position to the extended position; and

a biasing member for biasing the antenna assembly in the first direction, the biasing member having opposite ends respectively connected to the casing and the antenna assembly.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional wireless network card;

FIG. 2 is an exploded perspective view showing the preferred embodiment of an electronic device according to the present invention;

FIG. 3 is a perspective view showing a cam follower unit of the preferred embodiment;

FIG. 4 is a schematic side view showing the cam follower unit of FIG. 3;

FIG. 5 is a schematic top view illustrating the preferred embodiment when an antenna assembly is in a retracted position;

FIG. 6 is schematic top view illustrating the preferred embodiment when the antenna assembly is in an extended position; and

FIG. 6A is an enlarged view showing an encircled portion of FIG. 6.

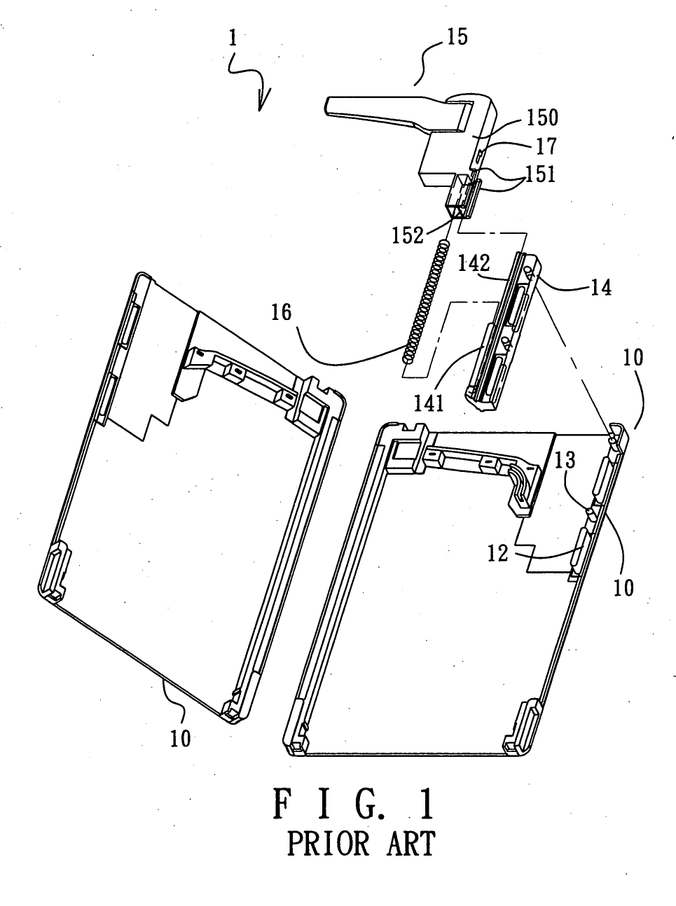

### DETAILED DESCRIPTION OF THE PREFERRED EMBODIMENT

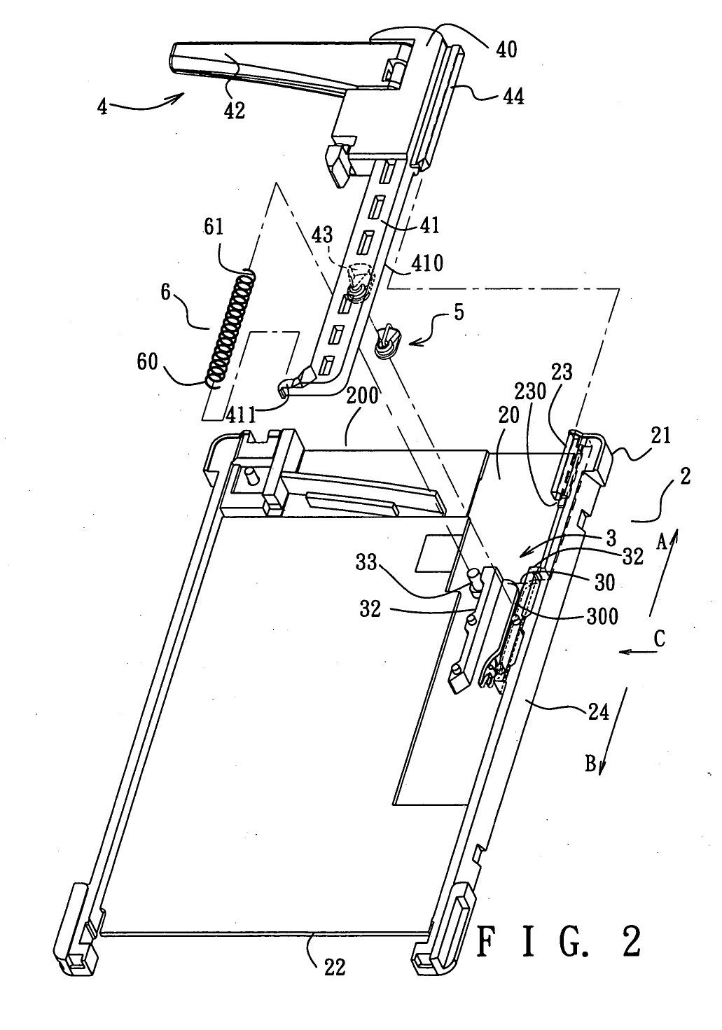

Referring to FIG. 2, the preferred embodiment of an electronic device according to the present invention is shown to be embodied in a wireless network card that includes a casing, a retractable antenna assembly 4, a cam follower unit 5, a cam groove unit 3, and a biasing member 6.

The casing 2, which consists of complementary casing parts 21 (only one casing part is shown) in this embodiment, confines a receiving space 20 and has an open end 200 for access into the receiving space 20. In this embodiment, the casing part 21 includes a bottom wall 22, and a lateral wall 24 connected to the bottom wall 22. The lateral wall 24 has an inner surface 23 formed with a first guiding groove 230 that is disposed adjacent to the open end 200.

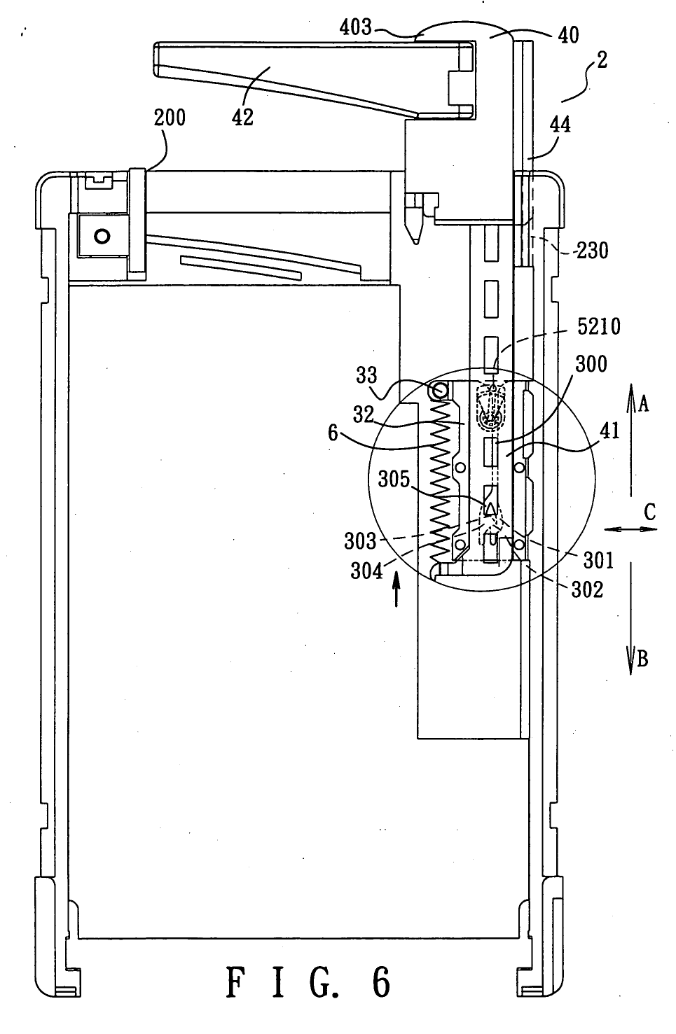

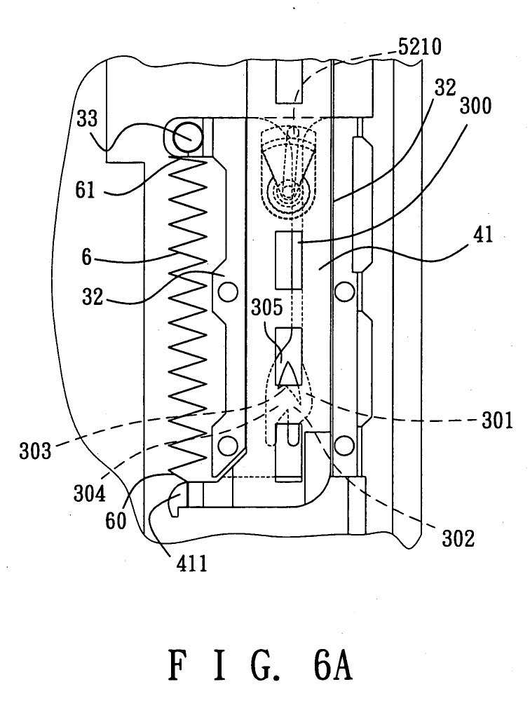

The antenna assembly 4 is operable so as to move relative to the casing 2 from a retracted position, where the antenna assembly 4 is retracted into the casing 2, as shown in FIG. 5, to an extended position, where the antenna assembly 4 extends outwardly of the casing 2 in a first direction (A) via the open end 200, as shown in FIG. 6. In this embodiment, the antenna assembly 4 includes an antenna-mounting seat 40, an antenna 42, and an elongate supporting frame 41. The antenna-mounting seat 40 is mounted movably in the casing 2, and has a lateral side facing the inner surface 23 of the lateral wall 24 of the casing part 21 and formed with a guiding block 44 that engages slidably the first guiding groove 230 in the lateral wall 24 of the casing part 21. The antenna 42 is mounted pivotally on the antenna-mounting seat 40. The supporting frame 41 is connected to the antenna-mounting seat 40, and is positioned slidably in a second guiding groove 30 confined by opposite positioning blocks 32 that are formed integrally on the bottom wall 22 of the casing part 21 and that are spaced apart from each other in a transverse direction (C) transverse to the first direction (A). The supporting frame 41 has a surface 410 facing the bottom wall 22 of the casing part 21 and formed with a recess 43. The supporting frame 41 further has a hook-shaped end 411 distal to the antenna-mounting seat 40 and engaging one of the positioning blocks 32 when the antenna assembly 4 is moved to the extended position in order to arrest further movement of the antenna assembly 4 in the first direction (A), as shown in FIG. 6.

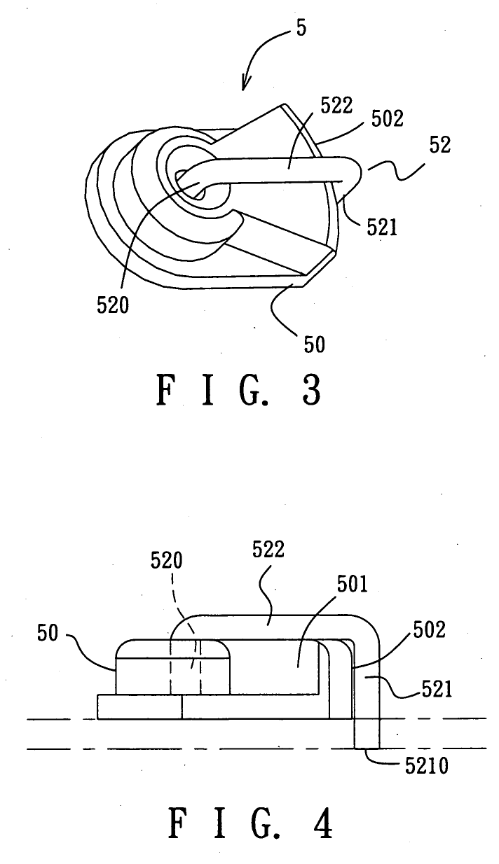

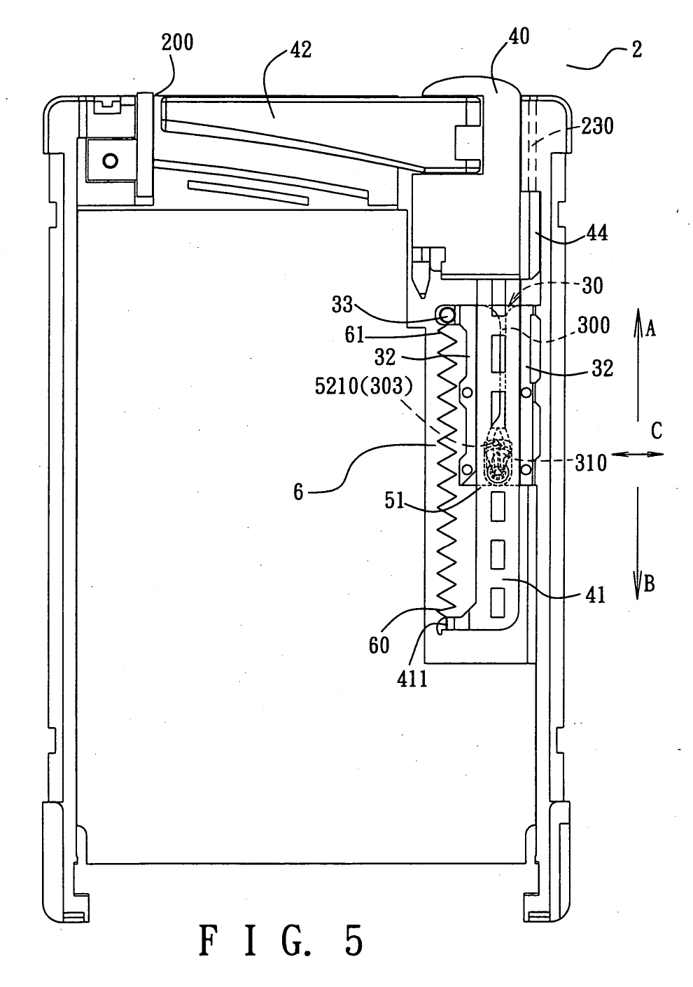

In this embodiment, the cam follower unit 5 is retained in the recess 43 in the supporting frame 41 of the antenna assembly 4. As shown in FIGS. 3 and 4, the cam follower unit 5 includes a base member 50 and a pivot member 52. The pivot member 52 includes parallel pivot arms 520, 521, and a joint 522 that interconnects the pivot arms 520, 521. The pivot arm 520 is connected pivotally to the base member 50. The pivot arm 521 is disposed over a curved edge 502 of the base member 50, and has a distal end 5210 that extends outwardly of the recess 43 in the supporting frame 41 of the antenna assembly 4.

In this embodiment, the cam groove unit 3 is formed in the bottom wall 22 of the casing part 21 of the casing 2, and permits extension of the distal end 5210 of the pivot arm 521 of the pivot member 52 thereinto and movement of the latter therealong. The cam groove unit 3 includes first to sixth cam grooves 300, 301, 302, 303, 304, 305, as best shown in FIG. 6A. The first cam groove 300 corresponds to the extended position of the antenna assembly 4. The second cam groove 301 permits sliding movement of the distal end 5210 of the pivot arm 521 of the pivot member 52 therealong when the antenna assembly 4 is moved in a second direction (B) opposite to the first direction (A) from the extended position to a first limit position. The third cam groove 302 permits sliding movement of the distal end 5210 of the pivot arm 521 of the pivot member 52 therealong when the antenna assembly 4 is moved in the first direction (A) from the first limit position to the retracted position. The fourth cam groove 303 corresponds to the retracted position of the antenna assembly 4, and receives the distal end 5210 of the pivot arm 521 of the pivot member 52 to arrest further movement of the antenna assembly 4 in the first direction (A). The fifth cam groove 304 permits sliding movement of the distal end 5210 of the pivot arm 521 of the pivot member 52 therealong when the antenna assembly 4 is moved in the second direction (B) from the retracted position to a second limit position. The sixth cam groove 305 permits sliding movement of the distal end 5210 of the pivot arm 521 of the pivot member 52 there along when the antenna assembly 4 is moved in the first direction (A) from the second limit position to the extended position.

In this embodiment, the biasing member 6 is a coiled spring which has opposite ends 61, 60 respectively connected to a connecting post 33 on the bottom wall 22 of the casing part 21 and the distal end 411 of the supporting frame 41 of the antenna assembly 4 for biasing the antenna assembly 4 in the first direction (A).

To sum up, due to the presence of the cam follower unit 5 and the cam groove unit 3, the antenna assembly 4 in the present invention can be securely and accurately positioned in one of the extended and retracted positions. Moreover, the cam groove unit 3, which is integrally formed in the casing part 21 of the casing 2, can be easily fabricated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electronic device comprising:
a casing;
a retractable antenna assembly disposed in said casing and operable so as to move relative to said casing from a retracted position, where said antenna assembly is retracted into said casing, to an extended position, where said antenna assembly extends outwardly of said casing in a first direction;
a cam follower unit including a pivot member coupled pivotally to said antenna assembly;
a cam groove unit formed in said casing, and including
a first cam groove that corresponds to the extended position of said antenna assembly,
a second cam groove that permits sliding movement of said pivot member of said cam follower unit therealong when said antenna assembly is moved in a second direction opposite to the first direction from the extended position to a first limit position,
a third cam groove that permits sliding movement of said pivot member of said cam follower unit therealong when said antenna assembly is moved in the first direction from the first limit position to the retracted position,
a fourth cam groove that corresponds to the retracted position of said antenna assembly, and that receives said pivot member of said cam follower unit to arrest further movement of said antenna assembly in the first direction,
a fifth cam groove that permits sliding movement of said pivot member of said cam follower unit therealong when said antenna assembly is moved in the second direction from the retracted position to a second limit position, and
a sixth cam groove that permits sliding movement of said pivot member of said cam follower unit therealong when said antenna assembly is moved in the first direction from the second limit position to the extended position; and
a biasing member for biasing said antenna assembly in the first direction, said biasing member having opposite ends respectively connected to said casing and said antenna assembly.

2. The electronic device as claimed in claim 1, wherein said cam follower unit further includes a base member retained on said antenna assembly, said pivot member including parallel pivot arms, and a joint that interconnects said pivot arms, one of said pivot arms being connected pivotally to said base member, the other one of said pivot arms being disposed over an edge of said base member and having a distal end that extends into said cam groove unit.

3. The electronic device as claimed in claim 1, wherein said biasing member is a coiled spring.

4. The electronic device as claimed in claim 1, wherein said casing is formed with a positioning block that engages said antenna assembly when said antenna assembly is moved to the extended position so as to arrest further movement of said antenna assembly in the first direction.
